(19) United States
(12) Patent Application Publication
(10) Pub. No.: US 2026/0278342 A1
(43) Pub. Date: Sep. 17, 2026

(54) SYSTEMS AND METHODS FOR CATEGORIZING ELECTRONIC TRANSACTIONS

(71) Applicant: The PNC Financial Services Group, Inc., Pittsburgh, PA (US)

(72) Inventors: Doru BALCAN, Pittsburgh, PA (US); Krishna VARIKOOTY, Pittsburgh, PA (US); Ross O'CONNELL, Pittsburgh, PA (US); Dale LINTNER, Pittsburgh, PA (US); Tara NAPOLITANO, Pittsburgh, PA (US); Tian ZHANG, Pittsburgh, PA (US); Ritika KHURANA, Pittsburgh, PA (US); Eric MYERS, Pittsburgh, PA (US)

(73) Assignee: The PNC Financial Services Group, Inc., Pittsburgh, PA (US)

(21) Appl. No.: 19/672,332

(22) Filed: May 8, 2026

Related U.S. Application Data
(63) Continuation of application No. 19/348,595, filed on Oct. 2, 2025.
(60) Provisional application No. 63/739,174, filed on Dec. 27, 2024.

(51) Int. Cl. G06N 3/0455; G06N 3/096; G06Q 20/38

(52) U.S. Cl. CPC G06N 3/0455; G06N 3/096; G06Q 20/382

(57) ABSTRACT

A system and method for categorizing electronic transactions are described. The system may execute instructions including receiving a first and a second transaction dataset, building a first and a second custom model by training the NLP model using the first and the second transaction dataset respectively, updating the first and the second custom model using a first part of a third transaction dataset to generate a first and a second tuned model, testing the first and the second tuned model using a second part of the third transaction dataset to obtain a first model performance score of the first tuned model and a second model performance score of the second tuned model, building a categorization model based on a determination that the first model performance score is greater than the second model performance score, and categorizing a latest transaction data to a corresponding category using the categorization model.

### CROSS REFERENCE TO RELATED APPLICATIONS

The present application claims the benefit of priority to U.S. Provisional Application No. 63/739,174, filed on Dec. 27, 2024, the entire contents of which are incorporated herein by reference.

### TECHNICAL FIELD

The present disclosure relates to systems and methods for categorizing electronic transactions. More specifically, the present disclosure relates to categorizing transactions by pre-trained natural language processing (NLP) with two stage fine-tuned process.

### BACKGROUND

Electronic transaction categorization at financial institutions may rely on two primary approaches. The first involves vendor-generated categorization mechanisms, which may be used for virtual wallet customers. These mechanisms may provide pre-built solutions but rely on external data processing and management. The second approach may involve internally developed, rules-based systems. For example, banking strategy analytic model (BSAM) categorization logic for small business accounts may include rules-based systems for credit intelligence on consumer cards and deposit analysis for deposit accounts. Additionally, institutions may rely on rules-based methods tailored to specific business needs for different businesses. What is needed, however, is a system capable of adapting to new or evolving transaction descriptions.

Additionally, sending transaction data in batches to third parties raises concerns about data privacy and regulatory compliance. Meanwhile, there is a need for mechanisms that address the need for some specific customizations.

Meanwhile, dependence on predefined transaction categories and descriptions may render systems ineffective or insufficiently effective. For instance, a rules-based system may categorize transactions accurately for known merchant codes or transaction descriptions but fail to handle ambiguous or previously unseen data effectively.

Accordingly, there is a need to provide a more adaptive and scalable solution that can handle dynamic transaction descriptions while meeting specific business requirements.

### SUMMARY

Consistent with embodiments of the present disclosure, a system for categorizing electronic transactions may include a memory and a processor. The memory may be configured to store instructions. The processor may be connected to the memory and configured to execute the instructions to select a natural language processing (NLP) model, wherein the NLP model is pretrained. The processor may also receive a first transaction dataset and a second transaction dataset. The processor may also build a first custom model by training the NLP model using the first transaction dataset and build a second custom model by training the NLP model using the second transaction dataset. The processor may also update the first custom model and the second custom model using a first part of a third transaction dataset to generate a first tuned model and a second tuned model. The processor may also test the first tuned model and the second tuned model using a second part of the third transaction dataset to obtain a first model performance score of the first tuned model and a second model performance score of the second tuned model. The processor may also build a categorization model based on a determination that the first model performance score is greater than the second model performance score, and categorize a latest transaction data to a corresponding category using the categorization model.

Also, consistent with embodiments of the present disclosure, there is provided a method for categorizing transactions. The method may be performed by at least one processor and may include receiving a first transaction dataset including transaction descriptions and corresponding first category labels generated by a first rules-based model and receiving a second transaction dataset comprising transaction descriptions and corresponding second category labels generated by an external labeling source. The method may also include tokenizing each transaction description from the first transaction dataset and second transaction dataset to generate a token sequence corresponding to each transaction description, each token sequence including a plurality of tokens. The method may also include converting each token in the token sequence into an embedded vector to form a sequence of embedded vectors and inputting the sequence of embedded vectors into a pre-trained transformer encoder model to generate a contextualized representation for each token. The transformer encoder may include a plurality of attention heads operating in parallel. The method may also include updating the pre-trained transformer encoder model using the first transaction dataset to generate a first custom classification model and updating the pre-trained transformer encoder model using the second transaction dataset to generate a second custom classification model. The method may also include receiving a third transaction dataset, which may include transaction descriptions and corresponding third category labels. The method may also include updating each of the first custom classification model and second custom classification model using the third transaction dataset. The method may also include evaluating the first custom classification model and second custom classification model, which may be updated using the third transaction dataset to compute a performance metric and selecting the first custom classification model or the second custom classification model as a transaction classification model based on the performance metric.

In addition, consistent with embodiments of the present disclosure, there is provided a method for categorizing transactions. The method may include tokenizing each transaction description from a training dataset to generate a sequence of tokens. Each token may be mapped to a numeric value. The method may also include embedding each of the numeric values into an embedded vector to represent each token in a continuous vector space. The method may also include generating a query vector, a key vector, and a value vector by applying corresponding learnable matrices for each of the embedded vectors. The method may also include performing a multi-head self-attention on each of the embedded vectors to generate a plurality of attention outputs. The method may also include combining the plurality of attention outputs to form a contextualized representation of each token. The method may also include processing the contextualized representations through a transformer encoder to generate a natural language processing (NLP) model. The method may also include training the NLP model using a first transaction dataset containing labels generated by a rules-based model. The method may also include updating the NLP model using a second transaction dataset containing labeled transaction data. The method may also include outputting a categorization model after updating the NLP model.

Consistent with embodiments of the present disclosure, a system for categorizing electronic transactions may include a memory and a processor. The memory may be configured to store instructions. The processor may be connected to the memory and configured to execute the instructions to receive a plurality of transaction datasets. Each of the transaction datasets may include a transaction description corresponding to a category label. The processor may also tokenize each of the transaction descriptions to generate token sequences, and generate embedded vectors based on the token sequences. The processor may also train a natural language processing (NLP) model using the embedded vectors and the category labels. The processor may also define a performance metric and evaluate the NLP model based on the performance metric. The processor may also determine whether the performance metric meets a predefined threshold. The processor may also build a categorization model based on the trained NLP model when the performance metric meets a predefined threshold. The processor may also categorize a latest transaction data to a corresponding category using the categorization model.

Furthermore, consistent with embodiments of the present disclosure, there is provided a method for categorizing transactions. The method may include receiving a transaction dataset including a transaction description. The method may also include tokenizing the transaction description to generate a token sequence and converting the token sequence into an embedded vector. The method may also include inputting the embedded vector into a natural language processing (NLP) model to generate a classification output corresponding to a transaction category and outputting the classification output with a probability value indicating a confidence score of at least one classification. The method may also include identifying a key token within the transaction description that may contribute to the classification output. The method may also include generating an analysis result based on an association between the key token and a plurality of labeled examples in the transaction dataset, the analysis result indicating reasoning behind the classification output.

Consistent with embodiments of the present disclosure, there is provided a method for categorizing transactions. The method may include tokenizing a plurality of transaction descriptions to generate a token sequence for each of the transaction descriptions and converting the token sequences into corresponding embedded vectors. The method may also include inputting the embedded vectors into a transformer-based model, which may include a multi-head attention mechanism to generate contextualized representations and training the transformer-based model using a first transaction dataset to produce a custom model. The method may also include updating the custom model using a second transaction dataset. The method may also include defining a performance metric for evaluating a model performance. The method may also include evaluating the custom model being updated using a third transaction dataset based on the performance metric. The method may also include building a categorization model when the custom model meets a predefined threshold of the performance metric. The method may also include categorizing a latest transaction data to a corresponding category by the categorization model.

Furthermore, embodiments of the present disclosure may also include computer systems, apparatus, processes, and computer programs recorded on one or more computer storage devices, each configured to perform the actions disclosed in the present disclosure.

It is to be understood that the foregoing general description and the following detailed description are exemplary and explanatory only and are not restrictive of the disclosed embodiments.

### BRIEF DESCRIPTION OF FIGURES

The accompanying drawings, which are incorporated in and constitute a part of this specification, illustrate disclosed embodiments and, together with the description, serve to explain the disclosed embodiments.

FIG. 1 illustrates an exemplary categorization mechanism for categorizing transactions.

FIG. 2 illustrates an exemplary process of building a transaction categorization model according to an embodiment of the present disclosure.

FIG. 3 illustrates an exemplary block diagram of a system for categorizing transactions according to an embodiment of the present disclosure.

FIG. 4 illustrates an exemplary consumption scenario of according to an embodiment of the present disclosure.

FIG. 5 illustrates an exemplary transformer encoder according to an embodiment of the present disclosure.

FIG. 6 illustrates exemplary accurate model predictions according to an embodiment of the present disclosure.

FIG. 7 illustrates exemplary inaccurate model predictions according to an embodiment of the present disclosure.

FIG. 8 illustrates a flow chart of a method for building the transaction categorization model according to an embodiment of the present disclosure.

FIG. 9 illustrates an exemplary loss function of a first tuned model that is fine-tuned at a first stage according to an embodiment of the present disclosure.

FIG. 10 illustrates an exemplary precision of the first tuned model that is fine-tuned at the first stage according to an embodiment of the present disclosure.

FIG. 11 illustrates an exemplary recall of the first tuned model that is fine-tuned at the first stage according to an embodiment of the present disclosure.

FIG. 12 illustrates an exemplary accuracy of the first tuned model that is fine-tuned at the first stage according to an embodiment of the present disclosure.

FIG. 13 illustrates an exemplary F1 score of the first tuned model that is fine-tuned at the first stage according to an embodiment of the present disclosure.

FIG. 14 illustrates an exemplary gradient norm of the first tuned model that is fine-tuned at the first stage according to an embodiment of the present disclosure.

FIG. 15 illustrates an exemplary loss function of the second tuned model that is fine-tuned at the second stage according to an embodiment of the present disclosure.

FIG. 16 illustrates an exemplary precision of the second tuned model that is fine-tuned at the second stage according to an embodiment of the present disclosure.

FIG. 17 illustrates an exemplary recall of the second tuned model that is fine-tuned at the second stage according to an embodiment of the present disclosure.

FIG. 18 illustrates an exemplary accuracy of the second tuned model that is fine-tuned at the second stage according to an embodiment of the present disclosure.

FIG. 19 illustrates an exemplary F1 score of the second tuned model that is fine-tuned at the second stage according to an embodiment of the present disclosure.

FIG. 20 illustrates an exemplary gradient norm of the second tuned model that is fine-tuned at the second stage according to an embodiment of the present disclosure.

FIG. 21 illustrates a flow chart of a method for building the transaction categorization model according to an embodiment of the present disclosure.

FIG. 22 illustrates a continued flow chart of the method for building the transaction categorization model shown in FIG. 21 according to an embodiment of the present disclosure.

FIG. 23 illustrates a flow chart of a method for building the transaction categorization model according to an embodiment of the present disclosure.

### DETAILED DESCRIPTION

Reference will now be made in detail to exemplary embodiments, discussed with reference to the accompanying drawings. Unless otherwise stated, technical and/or scientific terms have the meaning commonly understood by one of ordinary skill in the art. It is to be understood that other embodiments may be implemented and that changes may be made without departing from the scope of the disclosed embodiments. For example, unless otherwise indicated, method steps disclosed in the figures may be rearranged, combined, or divided without departing from the envisioned embodiments. Phrases that tend to indicate an order of events, such as “before,” “prior to,” then,” “after,” and the like are not intended to be limiting. Similarly, additional steps may be added, or steps may be removed, without departing from the envisioned embodiments. Thus, the materials, methods, and examples are illustrative only and are not intended to be necessarily limited.

Bank transactions represent the transfer of funds from one party to another or between accounts of the same party via checks, credit card usage, withdrawals, deposits, and other means. For example, each swipe of a credit card constitutes a new transaction. At a basic level, each transaction consists of a primary party, a counterparty, the transaction, and the transaction amount.

Transaction data is generated in high volumes daily and can be leveraged to support banks' analytical activities and strategic initiatives, e.g., credit risk modeling, fraud detection, marketing, etc. The challenge with such data is that it is highly variable and non-standardized. New counterparty names regularly appear, one counterparty name could appear in a variety of formats, and the number of possible counterparty names is too large for any useful analysis.

To facilitate analytical exercises, banks often assign each transaction to a category. A category can be assigned at different levels (generic such as “food” or specific such as “wholesale club”) and can describe different dimensions of the transaction, i.e., the type of transaction, such as “credit card purchase” or “direct deposit”, or the counterparty industry such as “grocery store”.

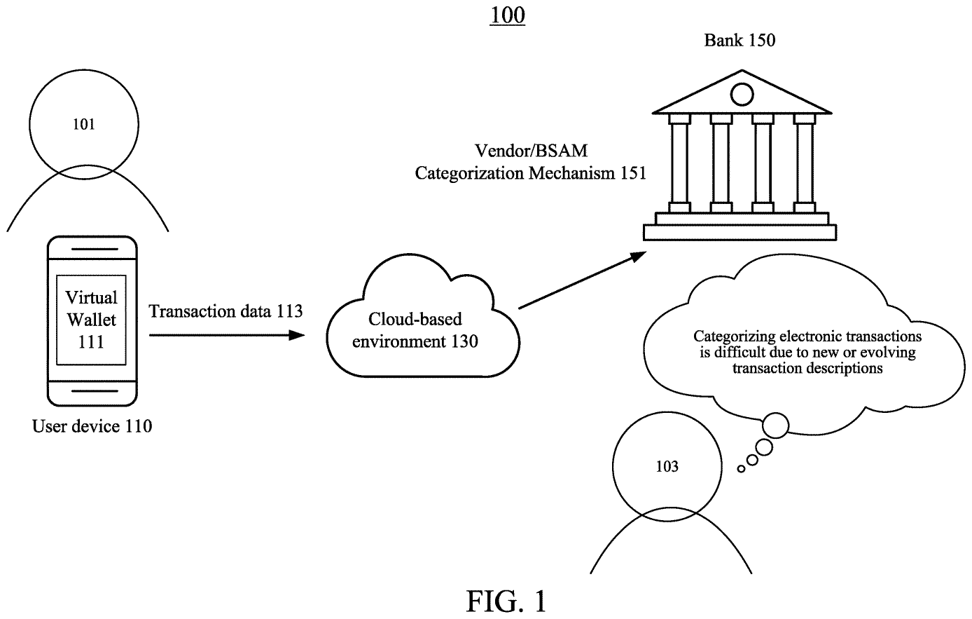

FIG. 1 illustrates an exemplary categorization mechanism for categorizing transactions. As shown in FIG. 1, a virtual wallet 111 may be operated on a user device 110. Virtual wallet 111 may generate transaction data 113 and transmit transaction data 113 to a cloud-based environment 130. Transaction data 113 may then be provided to bank 150. Bank 150 may adopt Vendor/BSAM categorization mechanism 151 for categorizing the incoming transaction data 113 and assign one or more transaction categories based on predefined rules or vendor logic. As further illustrated in FIG. 1, user 101 may represent a consumer conducting a purchase transaction through virtual wallet 111, while user 103 may represent a bank employee or transaction analyst monitoring the categorization results. User 103 may observe that categorizing electronic transactions is difficult due to new or evolving transaction descriptions.

In some embodiments, the exemplary categorization mechanism may provide generic categorization logic that may not be readily adaptable to the specific analytical applications of some banks, such as credit risk modeling, portfolio insight generation, fraud detection, and anti-money laundering. Under emerging open banking regulations requiring meaningful consumer control, such arrangements may not be well-suited to ensure immediate revocation of access and data deletion when requested by consumers.

Further, rules-based categorization systems may be capable only of processing known and predefined transaction descriptions, thereby requiring continual manual updates when new descriptions appeared. In some cases the maintenance burden of such rules-based categorization systems is significant because transaction descriptions may be varied and complex, resulting in high cost and inefficiency. Rules-based approaches also may lack semantic understanding and consequently suffer from reduced classification accuracy, particularly in the presence of ambiguous or novel transaction descriptions.

Moreover, because different groups within some banks each develop and maintain independent rules-based logic, the categorization results may be fragmented and inconsistent across an organization. As such, certain categorization mechanisms may produce inaccurate credit risk assessment, unreliable early warning indicators, diminished effectiveness of fraud and anti-money laundering detection, and distortion of customer-facing applications where misclassified transactions degraded the accuracy of consumer financial insights. Accordingly, there exists a need for improved methods of transaction categorization that overcome the shortcomings of both vendor-generated and rules-based approaches by providing greater flexibility, enhanced accuracy, reduced data risk, and consistency across organizational applications.

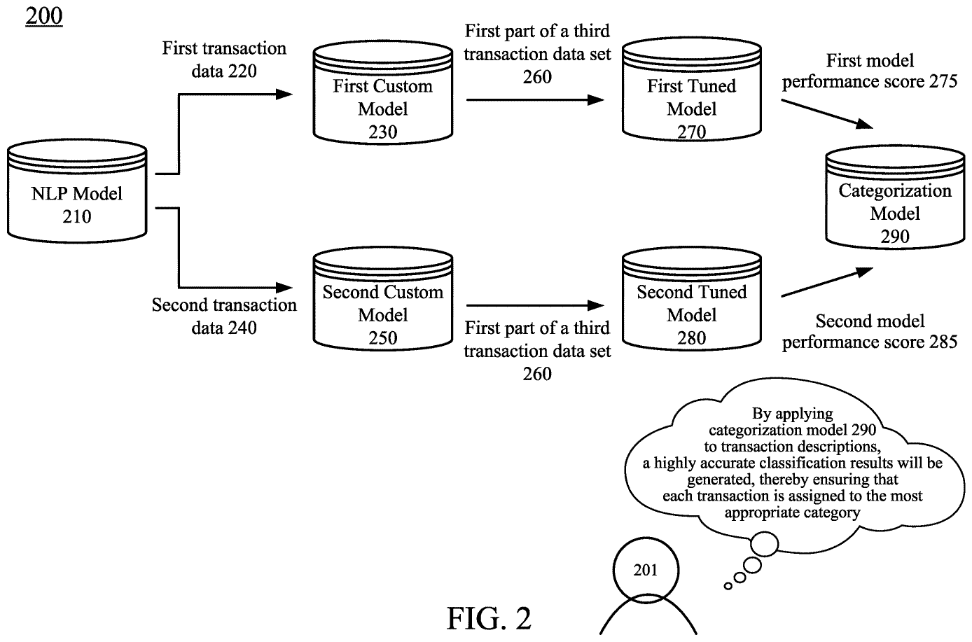

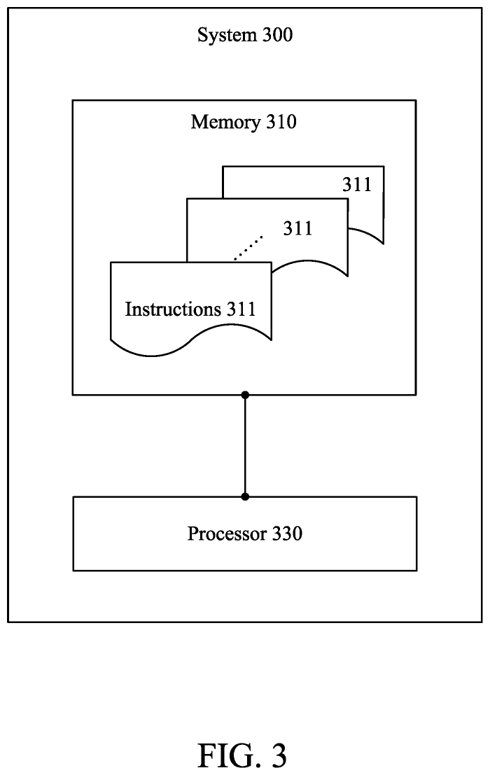

FIG. 2 illustrates an exemplary process 200 of building a transaction categorization model according to an embodiment of the present disclosure. FIG. 3 illustrates an exemplary block diagram of a system for categorizing transactions according to an embodiment of the present disclosure. As shown in FIG. 3, system 300 for categorizing electronic transactions may include memory 310 and processor 330. Memory 310 may store instructions 311. Processor 330 may be connected to the memory 310 and configured to execute the instructions 311 to train a natural language processing (NLP) model 210 into the categorization model 290. As further illustrated in FIG. 2, user 201 may represent a bank employee or transaction analyst observing the results of the categorization process. User 201 may recognize that by applying categorization model 290 to transaction descriptions, highly accurate classification results are generated, thereby ensuring that each transaction is assigned to the most appropriate category.

Specifically, processor 330 may select NLP model 210 as a base model for training. NLP model 210 may be pretrained. Processor 330 may also receive a first transaction dataset 220 and a second transaction dataset 240. First transaction dataset 220 may include a plurality of first transaction data. Each of the first transaction data may be labeled with a category label using a rules-based model. Second transaction dataset 240 may include a plurality of second transaction data. Each of the second transaction data may be labeled with a category label by the vendor of the NLP model.

Processor 330 may build a first custom model 230 by training NLP model 210 using first transaction dataset 220, and build a second custom model 250 by training NLP model 210 using the second transaction dataset 240. Then, processor 330 may update first custom model 230 and the second custom model 250 using a first part of a third transaction dataset 260 to generate a first tuned model 270 and a second tuned model 280.

Processor 330 may further test first tuned model 270 and second tuned model 280 using a second part of the third transaction dataset to obtain a first model performance score 275 of first tuned model 270 and a second model performance score 285 of the second tuned model 280. Processor 330 may then build a categorization model 290 based on a determination that the first model performance score 275 is greater than the second model performance score 285, and categorize a latest transaction data to a corresponding category using categorization model 290.

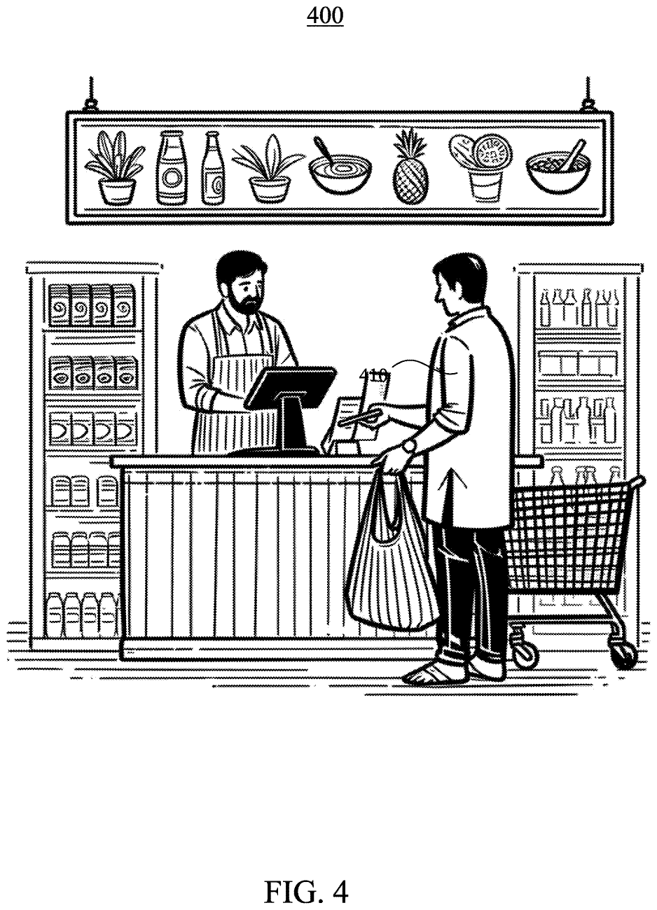

FIG. 4 illustrates an exemplary consumption scenario 400 according to an embodiment of the present disclosure. When customer 410 is performing a purchase at a supermarket checkout counter, a corresponding digital transaction record including a textual description of the merchant and goods may be generated and transmitted to the bank.

The transaction record may be processed by the system 300 of FIG. 3, which may classify the transaction into an appropriate category, such as “groceries” or “household goods.” By using comparative tuned models to improve data processing and categorization, categorization model 290 enhances accuracy, supports new transaction descriptions, and provides direct applicability to consumer financial management, credit risk assessment, fraud detection, and compliance applications. Enhanced accuracy, for example, results from reductions in the influence of potential but inapplicable categorization options and through the inclusion of trained NLP models capable of categorizing transactions. Support for new transaction descriptions, meanwhile, may be provided through the inclusion of NLP models capable of not only categorizing transactions, but also adding new transactions. NLP custom and/or tuned models may include novel categorization creation functionality lacking in other categorization models due to NLP's ability to analyze data across various sources to recognize new patterns. Moreover, by including custom models, the NLP models can be tailored to specific applications, such as consumer financial management, credit risk assessment, fraud detection, and compliance applications.

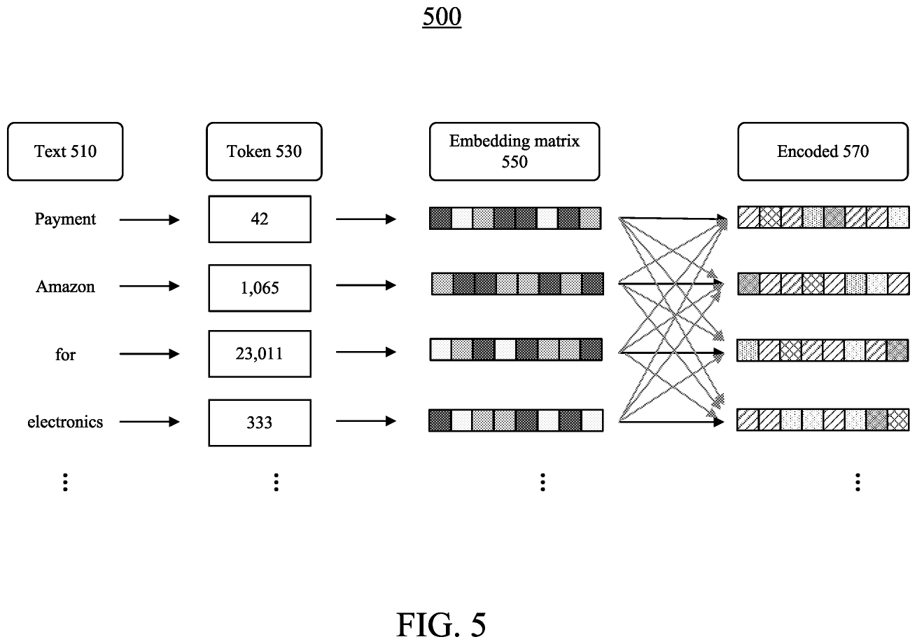

FIG. 5 illustrates an exemplary transformer encoder 500 according to an embodiment of the present disclosure. Transformer encoder 500 is a basic architecture of NLP model 210. Transformer encoder 500 may receive a sequence of input data and generate, for each element of the sequence, a corresponding vector representation that encodes both the intrinsic features of the element and its relationships to other elements in the sequence.

As shown in FIG. 5, a transaction description “Payment to Amazon for electronics” may be split into text 510, e.g., [“Payment”, “Amazon”, “for”, “electronics”]. Assuming that the vocabulary records part of correspondences between text 510 and values as follows:

| | |
|---|---|
| Payment | 42 |
| Amazon | 1,065 |
| for | 23,011 |
| electronics | 333 |

The transaction description “Payment Amazon for electronics” may be converted to a list of numerical sequences [“42”, “1,065”, “23,011”, “333”]. The list of numerical sequences may be in the form of token 530. This process may break text 510 down into basic units, which may be words or subwords that are easier to handle.

In some implementations, processor 330 may also split each of the transaction description into a first word and a second word, where the first word can be found in the vocabulary and the second word cannot be found in the vocabulary. In this case, processor 330 may map the first word to a first numeric value according to the vocabulary, and split the second word into a first subword and a second subword.

If processor 330 identifies the first subword and the second subword can be found in the vocabulary, then processor 330 may map the first subword and the second subword respectively to a second numeric value and a third numeric value based on the vocabulary and generate the numerical sequence for each of the transaction descriptions based on the first numeric value and the second numeric value and the third numeric value.

In some embodiments, if processor 330 only finds the first subword in the vocabulary, then processor 330 may map the first subword to the second numeric value and may map the second subword to an unknown label and generate the numerical sequence for each of the transaction descriptions based on the first numeric value and the unknown label. In some embodiments, processor 330 may further update the vocabulary based on the unknown label of the second subword.

After tokenizing text 510, processor 330 may convert each of the numeric values into embedding matrix 550 to map each of the numeric values to a dimensional vector. NLP model 210 may also generate a matrix that maps each token to a long vector. This long vector may enhance information indicating the position of each token 530 in the sentence, e.g., 1st word, 5th word, 87th word, etc. In other words, tokens 530 may be mapped to dense vectors in a high-dimensional space using an embedding matrix. Each token 530 may correspond to a unique vector that represents semantic and syntactic properties.

For example, if an embedding matrix is used from the pre-trained DistilBERT model to map each token of the numerical sequence [“42”, “1,065”, “23,011”, “333”], then an embedding vector may be assigned to each token of the transaction description “Payment Amazon for electronics”. These embedding vectors are high-dimensional representations that capture semantic relationships between tokens 530. The embedding matrix may be a fundamental component in natural language processing models that maps words or subwords into continuous vector representations. The embedding matrix may act as a lookup table that associates each token in vocabulary of NLP model 210 with a corresponding high-dimensional vector.

Processor 330 may then input the embedding vectors of tokens 530 of the transaction description to NLP model 210 for training and build the categorization model by training NLP model 210.

In some embodiments, when training NLP model 210, processor 330 may further generate a query vector, a key vector, and a value vector for each of the embedding vectors, may apply a self-attention mechanism to compute an attention score between the query vector and the key vector for each of tokens 530, and compute the attention scores.

The present disclosure may employ a strategy of transfer learning and fine-tuning to improve the performance of NLP model 210 for transaction categorization. Specifically, processor 330 may select a pretrained model, such as DistilBERT, which may have been trained on a general English language corpus to acquire a broad understanding of linguistic structures, including syntactic and semantic relationships between words. Processor 330 may then initialize NLP model 210 with the weights derived from the pretraining phase and performs additional training using a large set of labeled transaction data.

In this step, the labeled transaction data may include labels generated by rules-based logic or from the vendor, thereby enabling NLP model 210 to learn transaction-specific syntax and vocabulary patterns. This process may constitute transfer learning and allow knowledge acquired from general English language pretraining to be transferred and applied to the specialized task of transaction categorization.

Following the transfer learning step, processor 330 may further perform fine-tuning. In the fine-tuning phase, NLP model 210 may be trained on a smaller but higher-quality dataset, wherein the transaction labels may be assigned by expert analysts and/or may be assigned through analysis of additional data and may be considered a ground truth dataset. Through fine-tuning, the classification accuracy of NLP model 210 may be further enhanced to enable more precise handling of the highly variable transaction descriptions.

In one embodiment, the training process may be carried out iteratively, wherein labeled transaction data is input into the model, a loss value is computed based on the difference between predicted results and the corresponding labels, and the gradients are updated through an optimization algorithm to adjust the model parameters. This training loop may be repeated until the performance of the model on a validation dataset meets a predetermined criterion. By combining transfer learning with fine-tuning, the system integrates general language knowledge with domain-specific knowledge of financial transactions, thereby providing improved accuracy and reliability for applications including transaction categorization, credit risk assessment, fraud detection, and anti-money laundering.

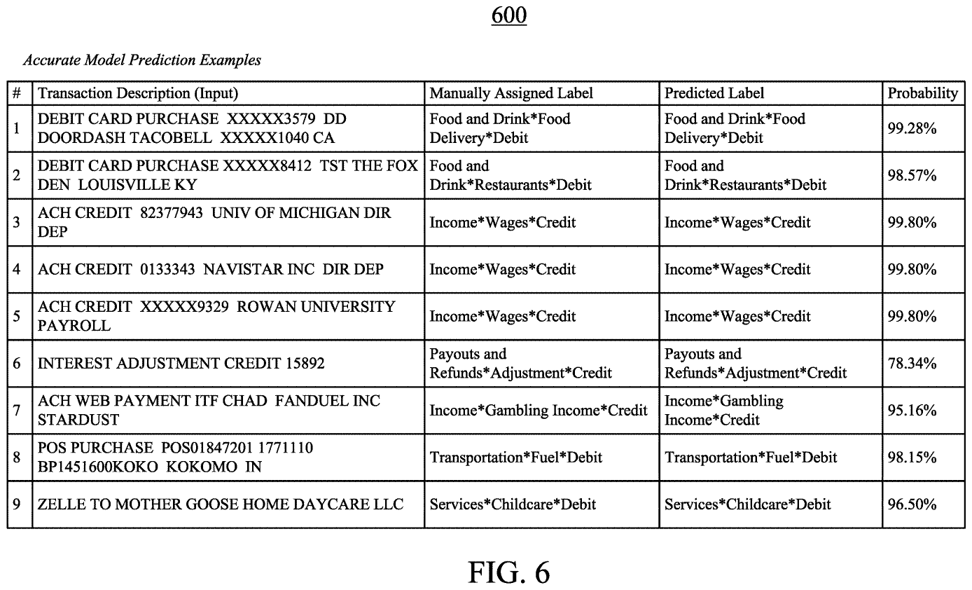

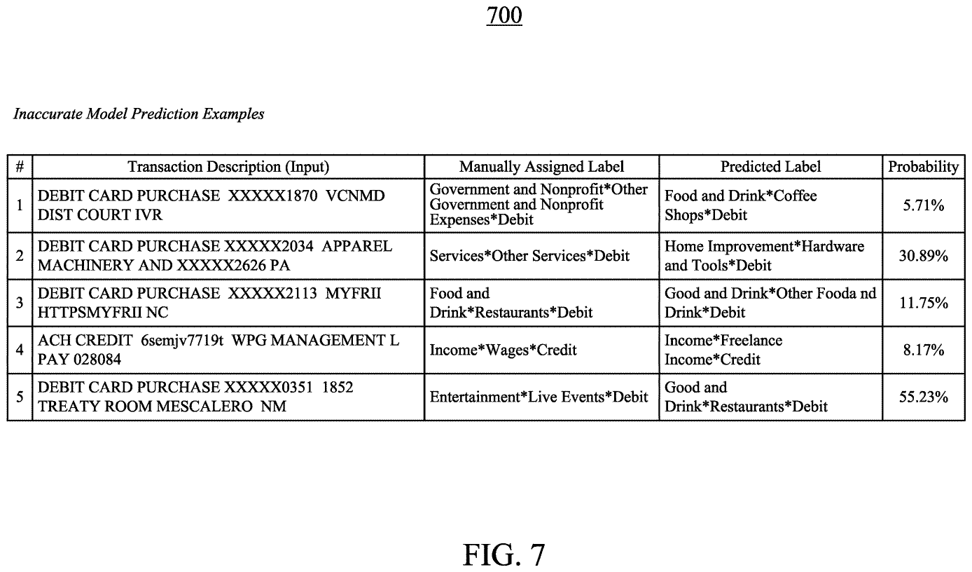

References are made to FIG. 6 and FIG. 7. FIG. 6 illustrates exemplary accurate model predictions according to an embodiment of the present disclosure. FIG. 7 illustrates exemplary inaccurate model predictions according to an embodiment of the present disclosure. As shown in FIG. 6, the predicted labels in row 1 through row 9 correspond closely to one or more assigned labels, thereby demonstrating the effectiveness of the first tuned model, which is fine-tuned at a second stage. In particular, row 1 illustrates a transaction containing the string “DOORDASH,” which the first tuned model accurately classifies with a probability of 99.28%, likely due to exposure to similar transactions during training. Row 2 demonstrates that the first tuned model correctly predicts the sub-category with a probability of 98.57%, based on recognition of the string “TST” and the merchant name “THE FOX DEN.”

Rows 3 through 5 show accurate classification of income transactions, each identified as “Income*Wages*Credit” with a probability of 99.80%, based on keywords such as “DIR DEP” and “PAYROLL.” Row 6 illustrates a case where the model assigns the same label as the manual classification “Payouts and Refunds*Adjustment*Credit” but with lower confidence 78.34%, likely due to the absence of distinct merchant identifiers in the transaction description. Row 7 demonstrates accurate classification of gambling income based on the string “FANDUEL INC.” Row 8 shows correct classification of a fuel purchase transaction with a probability of 98.15% based on the occurrence of “BP” and associated numerical identifiers. Row 9 illustrates accurate classification of a childcare-related payment with a probability of 96.50%, potentially based on the presence of the word “Daycare” or recognition of prior Zelle transactions to the same recipient.

As shown in FIG. 7, row 1 demonstrates a misclassification, where the first tuned model predicts “Coffee Shops” with a low probability of 5.71%, while the manual label corresponds to “Other Government and Nonprofit Expenses”. This suggests that the first tuned model had not previously observed similar transaction descriptions. Row 2 shows that the first tuned model predicts “Hardware and Tools” due to the presence of the word “MACHINERY,” whereas the manual label is “Other Services”. Row 3 illustrates that the model identifies the correct higher-level category but fails to assign the correct sub-category, with a low probability of 11.75%, reflecting the difficulty of interpreting the transaction description even for a human reviewer. Row 4 demonstrates that the model identifies the transaction as “Income” but incorrectly assigns the sub-category as “Freelance Income” rather than “Wages,” likely due to reliance on the string “PAY,” with an associated probability of 9.75%. Row 5 illustrates another misclassification, wherein the model predicts “Restaurant” while the manual label is “Live Event”. Additional investigation indicates that “1852 Treaty Room” refers to a cigar lounge, suggesting that neither classification may be optimal.

Accordingly, FIG. 6 and FIG. 7 collectively illustrate that the disclosed system can achieve highly accurate classifications for common transaction descriptions with distinctive features, while also identifying scenarios in which ambiguous or unfamiliar transaction descriptions may lead to misclassification or reduced prediction confidence. These examples further demonstrate the advantages of combining transfer learning with fine-tuning on specific transaction data to enhance classification accuracy and reliability.

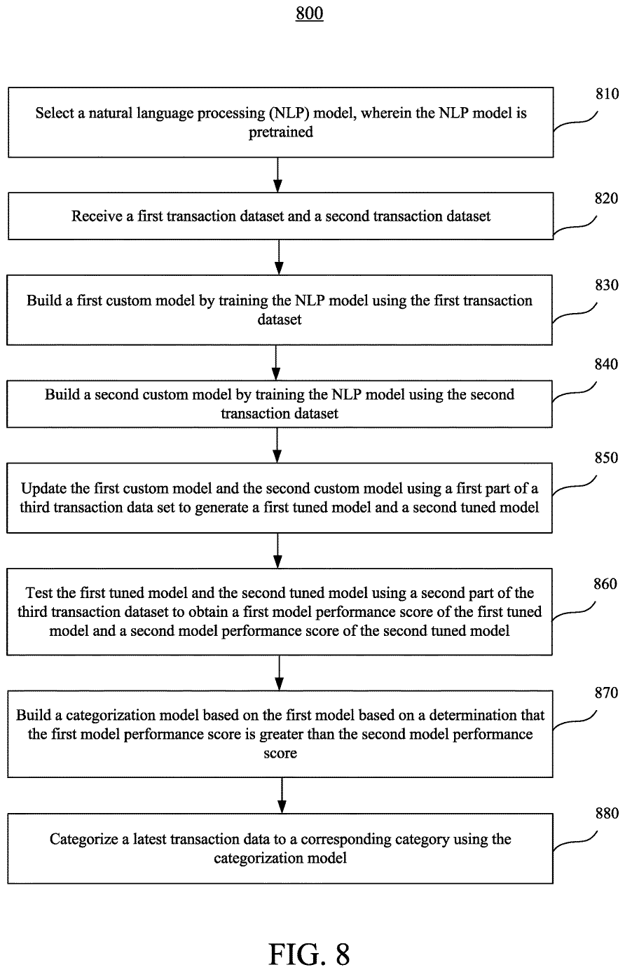

FIG. 8 illustrates a flow chart of a method 800 for building the transaction categorization model according to an embodiment of the present disclosure. In step 810, the method 800 may include selecting a natural language processing (NLP) model. The NLP model may be pretrained, such as bidirectional encoder representations from transformers (BERT), DistilBERT, or other models taken transformer-based encoder architecture as a base model.

In step 820, the method 800 may include receiving a first transaction dataset and a second transaction dataset. The first transaction dataset may include a plurality of first transaction data. Each of the first transaction data may be labeled with a category label using a rules-based model.

In step 830, the method may include building a first custom model by training the NLP model using the first transaction dataset. Specifically, before building the first custom model, the method may further include tokenizing a transaction description of each of the first transaction data to generate a numerical sequence, converting each of the numeric values into an embedded vector to map each of the plurality of tokens to a dimensional vector space, inputting the embedded vectors to the NLP model to train the NLP model, and further updating the first custom model by training the NLP model using the embedded vectors.

In some embodiments, the numerical sequences are generated based on a vocabulary of the NLP model. In some embodiments, tokenizing the transaction description may further include splitting a transaction description of each of the first transaction data into a first word and a second word, mapping the first word to a first numeric value based on the vocabulary, and splitting the second word into a first subword and a second subword. Upon determining the first subword and the second subword exist in the vocabulary, the method may further include mapping the first subword and the second subword respectively to a second numeric value and a third numeric value based on the vocabulary, and generating a numerical sequence for each of the transaction descriptions based on the first numeric value, the second numeric value, and the third numeric value.

In some embodiments, the method may further include mapping the first subword to the second numeric value upon determining the first subword exists in the vocabulary, mapping the second subword to an unknown label upon determining the second subword does not exist in the vocabulary, and updating the numerical sequence for each of the transaction descriptions based on the first numeric value, the second numeric value, and the unknown label. In some embodiments, the method may further include updating the vocabulary based on the unknown label of the second subword.

In step 840, the method may include building a second custom model by training the NLP model using the second transaction dataset. Training the NLP model using the second transaction dataset may include one or more steps recited above with respect to training the NLP model using the first transaction dataset.

In step 850, the method may include updating the first custom model and the second custom model using a first part of a third transaction data set to generate a first tuned model and a second tuned model.

In step 860, the method may include testing the first tuned model and the second tuned model using a second part of the third transaction dataset to obtain a first model performance score of the first tuned model and a second model performance score of the second tuned model.

In step 870, the method may include building a categorization model based on the first model based on a determination that the first model performance score is greater than the second model performance score.

In step 880, the method may include categorizing latest transaction data to a corresponding category using the categorization model.

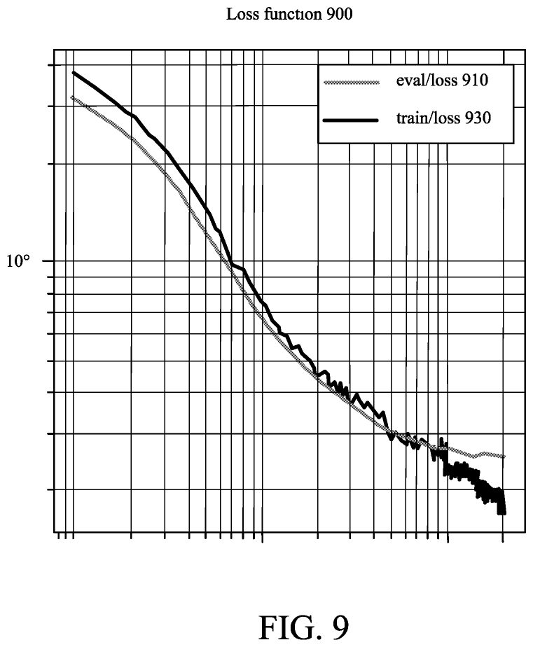

FIG. 9 illustrates an exemplary loss function 900 of a first custom model that is fine-tuned during a first stage according to an embodiment of the present disclosure. Loss function 900 may be computed as the cross-entropy between the true and predicted label distributions. In FIG. 9, the y-axis is plotted in logarithmic scale, and the x-axis represents the training steps executed across multiple mini-batches. As shown, curve 910 corresponds to the evaluation loss computed on validation samples, and curve 930 corresponds to the training loss computed on training samples.

Training loss decreases consistently as the model updates its parameters, indicating effective learning, while evaluation loss follows closely, demonstrating that the first tuned model generalizes well on unseen validation samples. At later training steps, a slight divergence between training loss and evaluation loss may be observed. This may suggest the onset of potential overfitting. However, such divergence remains minimal, and training is terminated prior to significant overfitting, thereby ensuring that the generalization capability of the first tuned model is preserved. Accordingly, FIG. 9 demonstrates that the first tuned model achieves improved performance and stability during the first fine-tuning stage.

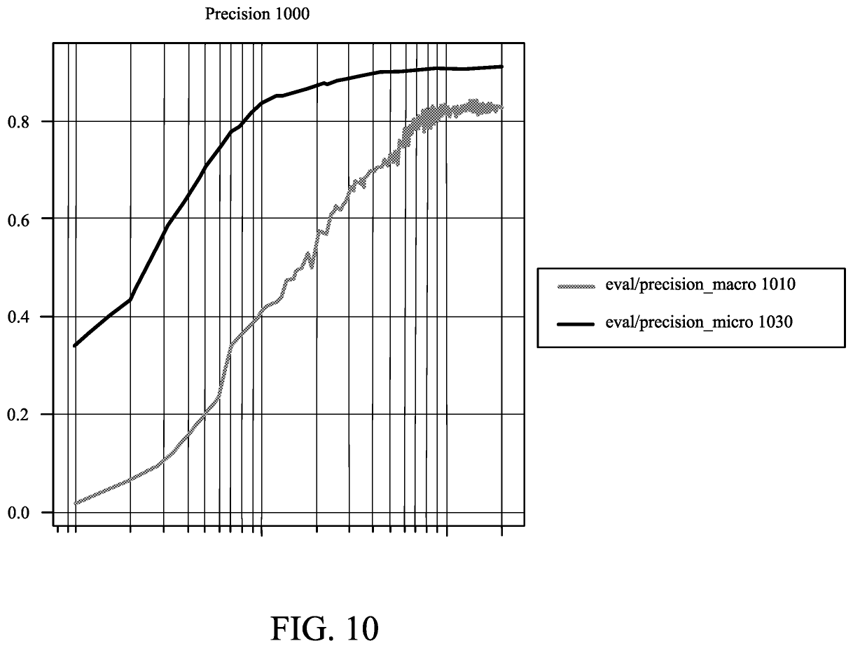

FIG. 10 illustrates an exemplary precision of the first tuned model that is fine-tuned at the first stage according to an embodiment of the present disclosure. Precision function 1000 may represent the ratio of correctly predicted positive samples to the total number of samples predicted as positive. The grey curve may correspond to macro-aggregated precision 1010, and the black curve may correspond to micro-aggregated precision 1030. Macro-aggregated precision 1010 and micro-aggregated precision 1030 may be computed on validation samples. As shown in FIG. 10, precision steadily improves throughout training, with micro-precision 1030 achieving higher and more stable values compared to macro-precision 1010. This indicates that the first tuned model effectively distinguishes positive predictions across frequent categories while progressively improving across less frequent categories.

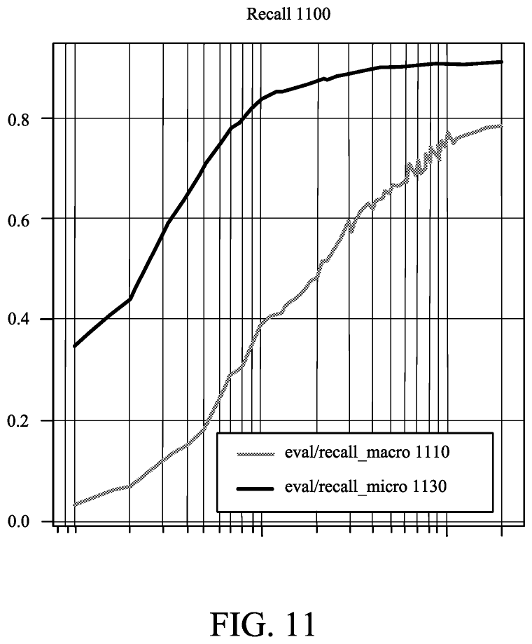

FIG. 11 illustrates an exemplary recall of the first tuned model that is fine-tuned at the first stage according to an embodiment of the present disclosure. Recall function 1100 represents the ratio of correctly predicted positive samples to the total number of actual positive samples. The grey curve may correspond to macro-aggregated recall 1110, and the black curve may correspond to micro-aggregated recall 1130. Both macro-aggregated recall 1110 and micro-aggregated recall 1130 may be computed on validation samples. The recall values may demonstrate a consistent upward trend, with micro-aggregated recall 1130 reaching higher values than macro-aggregated recall 1110, thereby confirming that the first tuned model increasingly captures a greater proportion of relevant transaction descriptions across the dataset.

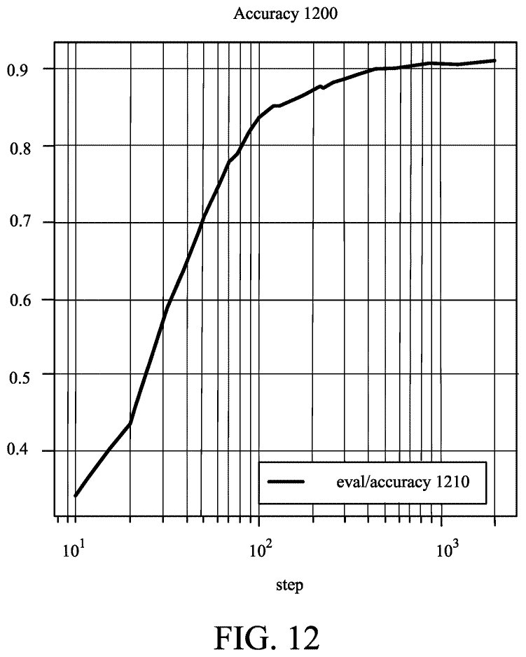

FIG. 12 illustrates an exemplary accuracy of the first tuned model that is fine-tuned at the first stage according to an embodiment of the present disclosure. Accuracy function 1200 corresponds to the ratio of all correctly predicted labels over the total number of validation samples. Curve 1210 shows that the evaluation accuracy begins at a relatively low baseline at the initial training steps and increases sharply during the early stage of fine-tuning, which reflects rapid parameter adjustment of the pretrained NLP model to transaction-specific data.

As training progresses, the accuracy curve continues to rise and eventually approaches a plateau above 90% which demonstrates that the first tuned model achieves reliable classification performance across a broad set of transaction categories. The plateau may indicate that the first tuned model reaches a point of diminishing returns, where additional training steps provide minimal improvement in predictive capability. This stabilization suggests that the first tuned model has converged to an optimal performance region while avoiding significant overfitting, thereby confirming its robustness and generalization capability to unseen transaction descriptions.

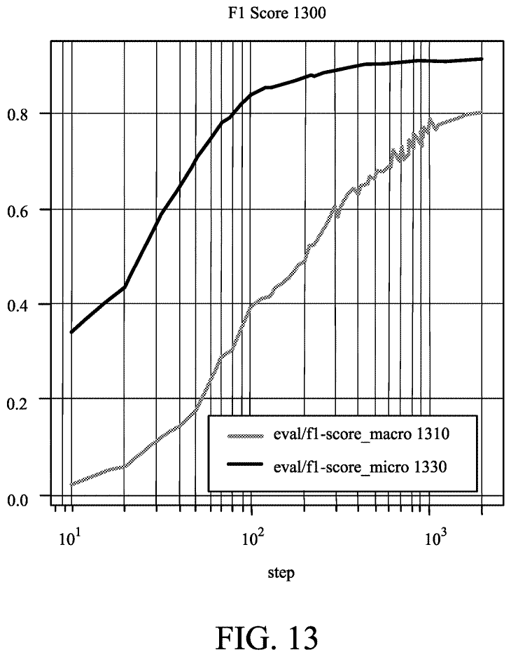

FIG. 13 illustrates an exemplary F1 score 1300 of the first tuned model that is fine-tuned at the first stage according to an embodiment of the present disclosure. F1 score 1300 may represent the harmonic mean of precision and recall, thereby providing a single metric that balances both the ability of the model to avoid false positives and its ability to minimize false negatives. As shown, the grey curve may correspond to macro-aggregated F1 1310, which averages the F1 values across all categories regardless of frequency, while the black curve may correspond to micro-aggregated F1 1330, which computes the F1 score globally by considering the aggregate contributions of all classes.

Both F1 metrics steadily increase over successive training steps, with micro-aggregated F1 1330 consistently outperforming macro-aggregated F1 1310. This indicates that the first tuned model achieves particularly strong performance on high-frequency transaction categories, while also progressively improving on less frequent categories. The rising trend of the macro-aggregated F1 curve 1310 further confirms that the fine-tuning process enhances the model's capability to generalize across rare transaction categories, which are often more challenging for traditional rule-based categorization systems.

Accordingly, FIG. 13 demonstrates that the first custom model achieves a balanced and reliable classification performance by jointly optimizing precision and recall during the first fine-tuning stage.

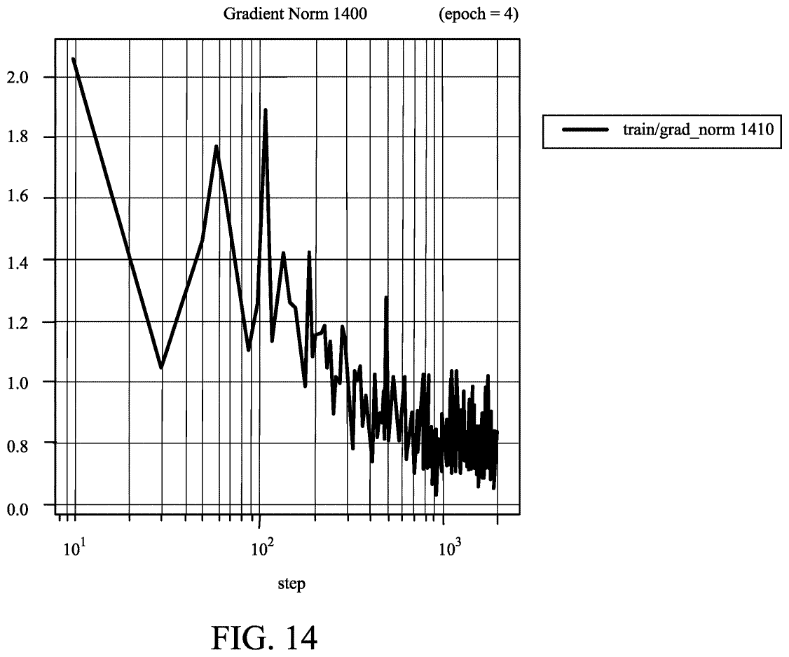

FIG. 14 illustrates an exemplary gradient norm of the first tuned model that is fine-tuned at the first stage according to an embodiment of the present disclosure. Gradient norm 1400 may represent the Euclidean norm of the gradient vector computed during backpropagation, which may measure the magnitude of the parameter updates at each training step. As shown, the black curve may demonstrate that the gradient norm curve 1410 is initially high at the beginning of training, reflecting substantial adjustments required to adapt the pretrained NLP model to transaction-specific data.

Over successive training steps, gradient norm curve 1410 may decrease and gradually stabilize, indicating that the parameter updates become smaller as the model approaches convergence. The reduction in gradient magnitude confirms that the loss landscape is being effectively minimized and that the model has reached a region of stable optimization. Occasional fluctuations in the curve correspond to local adjustments required for difficult or less frequent transaction categories, but the overall downward trend demonstrates stability in the fine-tuning process. The stabilization of gradient norm curve 1410 may indicate that the first tuned model avoids issues such as gradient explosion or vanishing gradients, thereby ensuring robust convergence and preventing excessive or erratic parameter updates.

Accordingly, FIG. 14 validates that the first tuned model achieves training stability and reliable optimization during the first fine-tuning stage.

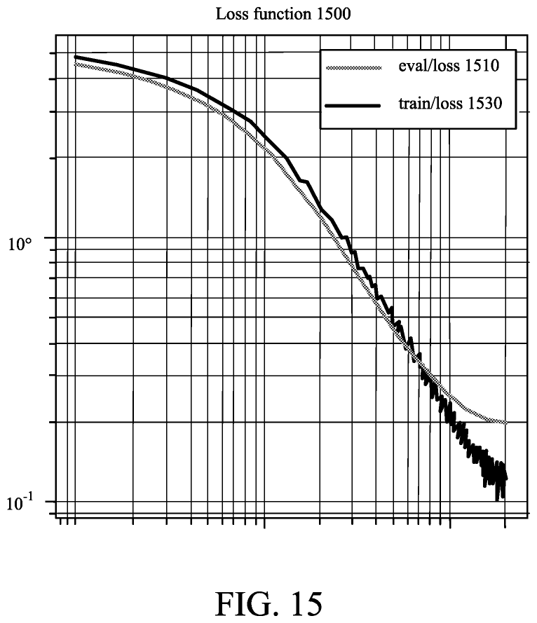

FIG. 15 illustrates an exemplary loss function of the second tuned model that is fine-tuned at the second stage according to an embodiment of the present disclosure. Loss function 1500 may be calculated as the cross-entropy between the true label distribution and the predicted label distribution. The grey curve may correspond to evaluation loss 1510 computed on validation samples, while the black curve may correspond to training loss 1530 computed on training samples.

As shown in FIG. 15, training loss 1530 decreases consistently as the training steps progress, indicating that the model parameters are being updated effectively to reduce classification error. Evaluation loss 1510 follows a similar downward trend and remains close to training loss 1530 for the majority of the training process, demonstrating that the model generalizes well to unseen validation samples.

Toward the later stages of training, a slight divergence is observed between evaluation loss 1510 and training loss 1530. This may suggest the onset of potential overfitting. However, the divergence remains limited, and training is terminated before significant overfitting occurs, thereby preserving the second tuned model's generalization capability.

The vertical axis is plotted on a logarithmic scale to represent the loss values, and the horizontal axis represents the training steps executed across multiple mini-batches. The overall trend of the curves clearly demonstrates the effective convergence achieved during the second fine-tuning stage and may confirm that the adjustments successfully enhance model performance and improve accuracy in categorizing transaction descriptions based on the manually labeled dataset.

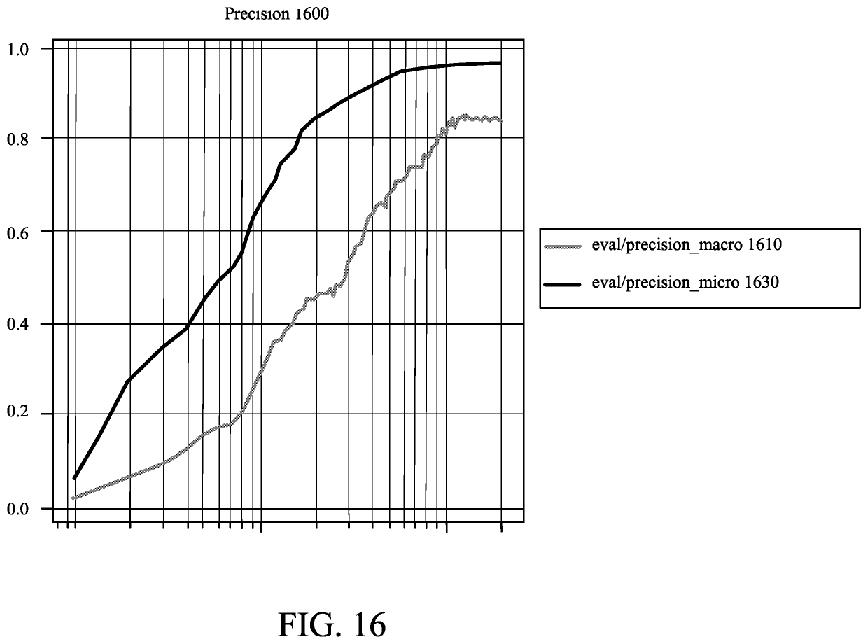

FIG. 16 illustrates an exemplary precision of the second tuned model that is fine-tuned at the second stage according to an embodiment of the present disclosure. Precision 1600 may be computed as the ratio of correctly predicted positive samples over the total number of samples predicted as positive. In the illustrated embodiment, the grey curve may represent the macro-aggregated precision 1610 computed across all classes with equal weight, while the black curve may represent the micro-aggregated precision 1630 computed by weighting each class proportionally to its support in the validation dataset.

As shown in FIG. 16, both macro-aggregated precision 1610 and micro-aggregated precision 1630 steadily increase as the training steps progress. Micro-aggregated precision 1630 achieves a higher value more quickly, reflecting the second tuned model's strong performance on more frequently occurring categories in the transaction dataset. Conversely, macro-aggregated precision 1610 increases more gradually, highlighting the additional difficulty in maintaining balanced precision across less frequent categories.

At later training steps, both curves approach a plateau, with micro-aggregated precision 1630 reaching approximately 0.95 and macro-aggregated precision 1610 reaching approximately 0.85. This demonstrates that the second tuned model not only performs well in predicting common categories but also achieves stable precision across rare or underrepresented categories, though with slightly lower accuracy compared to frequent classes.

The results may indicate that the fine-tuning process using manually labeled data enables the model to achieve robust precision across the entire label space, thereby improving the reliability of predictions for transaction categorization tasks. The consistent upward trend and eventual stabilization of both curves further confirm that the second tuned model is well-calibrated and less prone to false positives in its classification outputs.

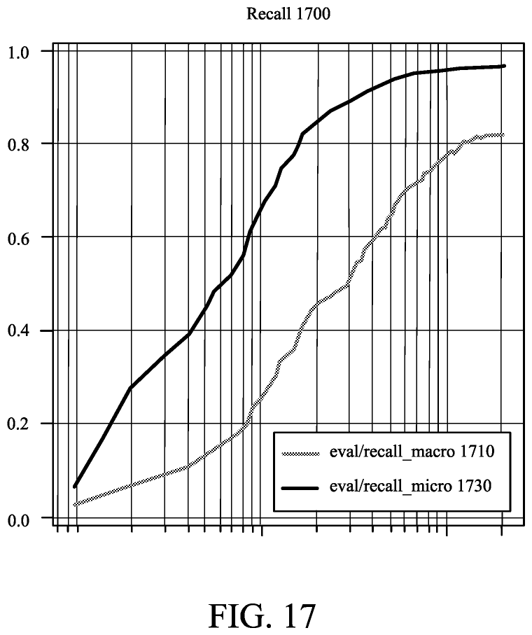

FIG. 17 illustrates an exemplary recall of the second tuned model that is fine-tuned at the second stage according to an embodiment of the present disclosure.

Recall is computed on the validation set as the ratio of correctly predicted positive instances to the total number of actual positive instances. In the illustrated embodiment, the grey curve denotes the macro-aggregated recall 1710 obtained by averaging per-class recalls with equal weight, while the black curve denotes the micro-aggregated recall 1730 obtained by aggregating true positives and false negatives over all classes prior to forming the ratio. The x-axis represents the number of training steps in logarithmic scale; the y-axis ranges from 0 to 1.

As training progresses, both macro and micro recall improve. The micro-recall curve 1730 rises rapidly from a low initial value and approaches a plateau near 0.97-0.98, indicating that the second tuned model recovers the vast majority of relevant transactions across the dataset and makes progressively fewer false-negative errors. The macro-recall curve 1710 increases more gradually, accelerating during mid-training and ultimately stabilizing around 0.80-0.83, which evidences improved recovery even for rarer or more difficult classes, albeit at levels slightly below the frequent classes reflected by micro-recall.

The persistent gap between micro-aggregated recall 1730 and macro-aggregated recall 1710 reflects the inherent class-imbalance of transaction categories and frequent categories are detected more completely, while infrequent categories remain comparatively harder. Nevertheless, the steady upward trend of the macro-recall demonstrates that the second-stage fine-tuning with manually labeled “ground truth” effectively reduces false negatives for minority classes. These dynamics may be leveraged for control policies such as class-balanced sampling or loss-weighting should further equalization across classes be desired.

In conjunction with the loss behavior observed for this stage, the recall curves' stabilization without degradation indicates convergence without material overfitting. Accordingly, FIG. 17 shows that the second tuned model achieves high coverage of true positives across the label space, with markedly improved recall relative to the first fine-tuning stage and robust generalization on unseen validation transactions.

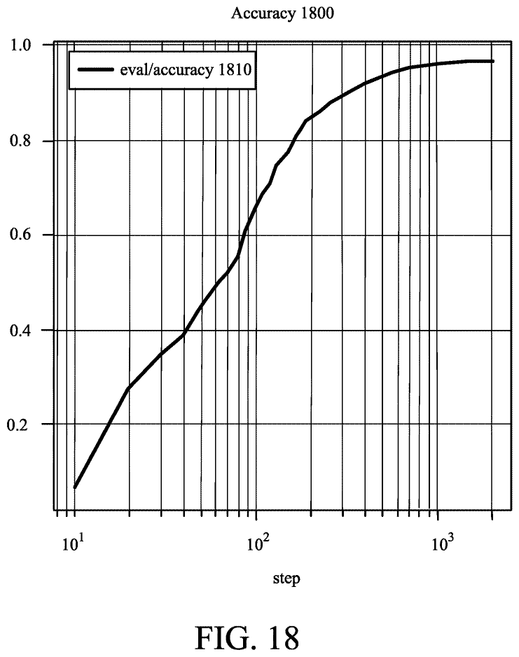

FIG. 18 illustrates an exemplary accuracy of the second tuned model that is fine-tuned at the second stage according to an embodiment of the present disclosure. Accuracy is computed on the validation set as the ratio of correctly predicted labels to the total number of validation samples. The black curve denotes evaluation accuracy 1810 which depicts the evaluation accuracy over training steps, the x-axis denotes the number of training steps in logarithmic scale, and the y-axis ranges from 0 to 1.

As shown in FIG. 18, evaluation accuracy 1810 begins at a low baseline during the earliest steps and rises steeply through the initial portion of training, reflects rapid adaptation of the pretrained encoder to transaction-specific language. Evaluation accuracy 1810 then continues to increase at a moderated rate and ultimately approaches a plateau near 0.96-0.97 to indicate that additional steps yield diminishing returns and that the model has reached a region of stable performance.

The improvement without subsequent degradation is consistent with the loss behavior observed for this stage and indicates convergence without material overfitting. The high terminal accuracy demonstrates that the second tuned model attains reliable end-to-end categorization performance on unseen, manually labeled validation transactions.

Operationally, the inflection and plateau behavior of evaluation accuracy 1810 may be used to trigger training controls, such as early stopping when the incremental accuracy gain between successive checkpoints falls below a threshold, or selection of the checkpoint with the highest validation accuracy for deployment. The observed accuracy exceeds that achieved in the first fine-tuning stage, corroborating that (i) the second stage benefits from knowledge transferred from the first stage and (ii) the use of expert “ground-truth” labels improves generalization quality.

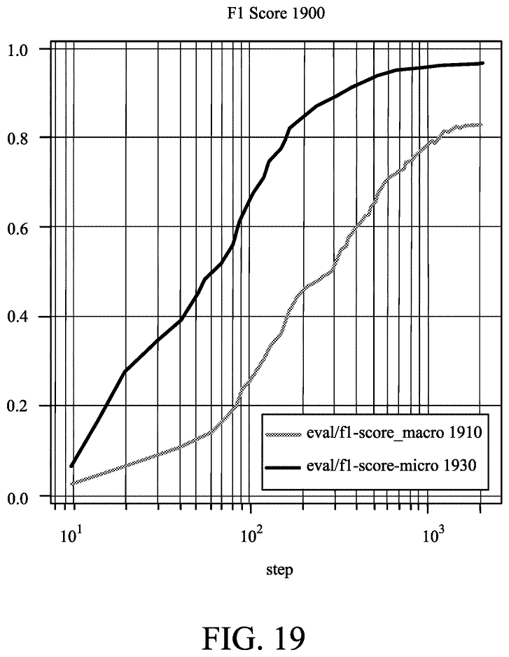

FIG. 19 illustrates an exemplary F1 score of the second tuned model that is fine-tuned at the second stage according to an embodiment of the present disclosure. F1 score 1900 may be computed on the validation set as the harmonic mean of precision and recall, thereby providing a single metric that jointly reflects reductions in both false positives and false negatives. The grey curve denotes the macro-aggregated F1 1910 obtained by averaging per-class F1 scores with equal weight across classes, while the black curve denotes the micro-aggregated F1 1930 obtained by aggregating true/false positives and false negatives across all classes before computing the F1. The x-axis shows training steps in logarithmic scale, and the y-axis spans 0 to 1.

As training proceeds, both the macro-aggregated F1 1910 and the micro-aggregated F1 1930 increase. Micro-aggregated F1 1930 rises steeply during early steps, surpasses 0.80 around mid-training, and ultimately plateaus near 0.95-0.97, indicating strong overall performance across the validation set. Macro-aggregated F1 1910 may grow more gradually, exhibit an inflection in mid-training as the model improves on harder or rarer categories, and stabilize around 0.83-0.85. This behavior evidences that the second tuned model not only excels on high-frequency categories but also progressively lifts performance on minority classes.

The persistent gap between macro-aggregated F1 1910 and micro-aggregated F1 1930 reflects underlying class imbalance, frequent categories dominate the global statistics, and the narrowing of this gap over time indicates that second-stage fine-tuning with expert “ground-truth” labels effectively improves balanced performance and reduces both false positives and false negatives for underrepresented categories.

Operationally, the joint trend of macro-aggregated F1 1910 and micro-aggregated F1 1930 may be employed as a control signal for training management: e.g., (i) early stopping when both macro-aggregated F1 1910 and micro-aggregated F1 1930 plateau within a tolerance, (ii) checkpoint selection that maximizes macro-aggregated F1 1910 when per-class parity is prioritized or micro-aggregated F1 1930 when overall throughput is prioritized, and (iii) adjustment of decision thresholds or class-weighted losses if additional equalization across classes is desired.

In combination with the loss, precision, recall, and accuracy behaviors observed for this stage, FIG. 19 may confirm that the second tuned model achieves a balanced and converged classification performance on unseen, manually labeled transactions, with F1 levels exceeding those attained in the first fine-tuning stage and without indications of material overfitting.

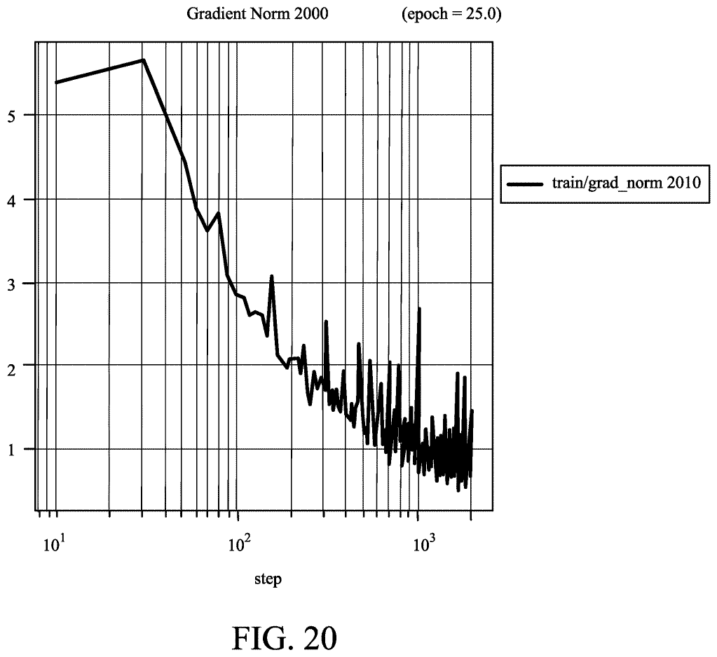

FIG. 20 illustrates an exemplary gradient norm of the second tuned model that is fine-tuned at the second stage according to an embodiment of the present disclosure. Gradient norm 2000 may measure the magnitude of the gradient vector used to update the model parameters during backpropagation. The black curve denotes gradient norm curve 2010, which depicts the gradient norm at each training step. The x-axis represents the training steps on a logarithmic scale, while the y-axis represents the gradient norm. Gradient norm 2000 shown in FIG. 20 is annotated with epoch=25.0 to indicate that the second fine-tuning stage was performed over 25 epochs.

As shown in FIG. 20, gradient norm curve 2010 begins at a relatively high level (approximately 5-5.5) during the early training steps and exhibits a slight initial increase, reflecting substantial parameter adjustments required for the pretrained encoder to adapt to the manually labeled transaction dataset. As training progresses, the gradient norm decreases rapidly from around step 10210\hat{ }2102 to a value near 2 and subsequently falls further into a narrower band of approximately 0.8-1.2 with small oscillations. This indicates that the magnitude of parameter updates becomes smaller and the optimization process approaches stable convergence.

Intermittent spikes are observed in the mid to later stages, typically corresponding to mini-batches containing difficult or low-frequency categories that require larger corrections. However, the overall downward trend remains consistent, and the oscillations remain controlled, with no evidence of gradient explosion or gradient vanishing. This behavior aligns with the flattening of the loss, accuracy, and F1 score curves during the same stage, confirming that the model achieves robust convergence without significant overfitting.

In practical implementation, gradient norm curve 2010 may serve as a control signal during training. When the gradient norm remains at a low and stable level for an extended duration, an early stopping condition may be triggered. Conversely, if short-term spikes exceed a threshold, gradient clipping or learning rate adjustment may be employed to maintain stability. Accordingly, FIG. 20 demonstrates that the optimization dynamics of the second fine-tuning stage are stable and controllable, thereby supporting the model's high generalization performance on the manually labeled validation dataset.

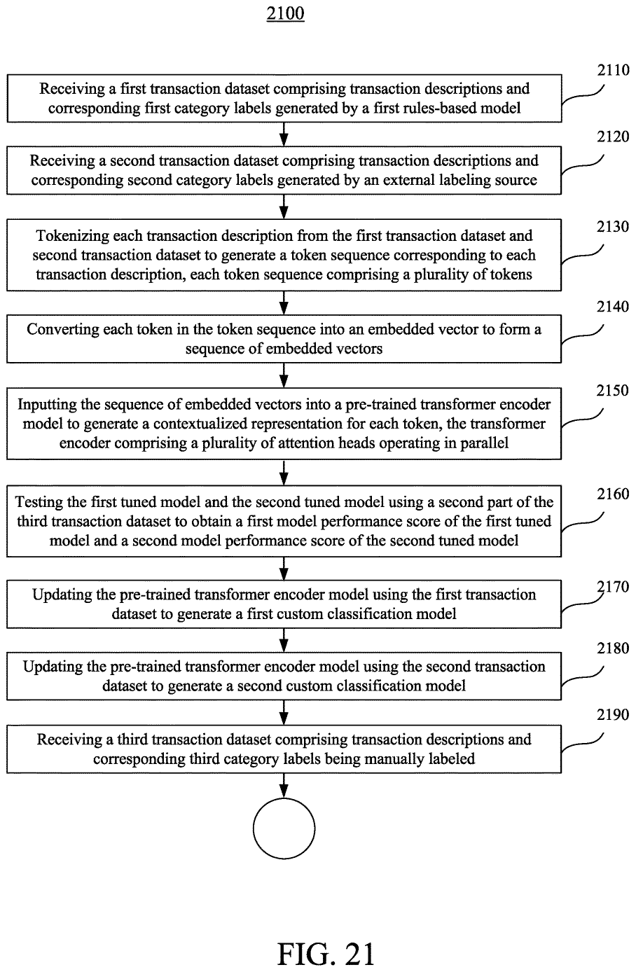

FIG. 21 illustrates a flow chart of a method 2100 for building the transaction categorization model according to an embodiment of the present disclosure. In step 2110, the method 2100 may include receiving a first transaction dataset including transaction descriptions and corresponding first category labels generated by a first rules-based model. Each of the first transaction data may be labeled with a category label using a rules-based model.

In step 2120, the method 2100 may include receiving a second transaction dataset, which may include transaction descriptions and corresponding second category labels generated by an external labeling source.

In step 2130, the method 2100 may include tokenizing each transaction description from the first transaction dataset and second transaction dataset to generate a token sequence corresponding to each transaction description. Each token sequence may include a plurality of tokens. Each of the tokens may correspond to a numeric value, and the numerical sequences may be generated based on a vocabulary of the NLP model. Tokenizing may further include splitting a transaction description into words and subwords, mapping the words and subwords to corresponding numeric values when they exist in the vocabulary, and mapping unknown subwords to an unknown label.

In step 2140, the method 2100 may include converting each token in the token sequence into an embedded vector to form a sequence of embedded vectors. Each of the numeric values is mapped to a dimensional vector space.

In step 2150, the method 2100 may include inputting the sequence of embedded vectors into a pre-trained transformer encoder model to generate a contextualized representation for each token. The transformer encoder may include a plurality of attention heads operating in parallel. Query, key, and value vectors may be generated for each embedded vector. The transformer encoder may calculate attention scores based on dot product operations and scaled normalization, apply a softmax function to obtain attention weights, and compute weighted sums of value vectors to form updated representations.

In step 2160, the method 2100 may include testing the first tuned model and the second tuned model using a second part of the third transaction dataset to obtain a first model performance score of the first tuned model and a second model performance score of the second tuned model. The performance metrics may include at least an F1 score, a precision score, a recall score, and an accuracy score.

In step 2170, the method 2100 may include updating the pre-trained transformer encoder model using the first transaction dataset to generate a first custom classification model.

In step 2180, the method 2100 may include updating the pre-trained transformer encoder model using the second transaction dataset to generate a second custom classification model.

In step 2190, the method 2100 may include receiving a third transaction dataset comprising transaction descriptions and corresponding third category labels being manually labeled.

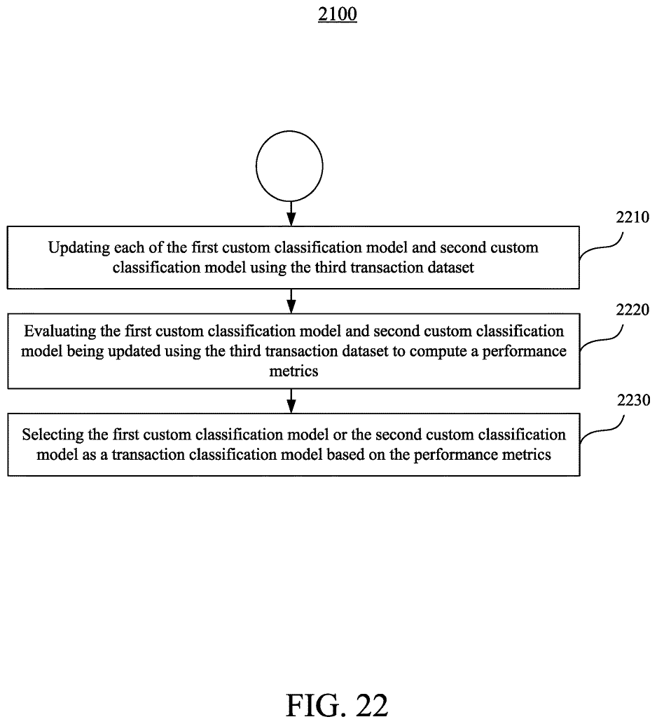

The method 2100 continues in FIG. 22.

In step 2210, the method 2100 may include updating each of the first custom classification model and second custom classification model using the third transaction dataset.

In step 2220, the method 2100 may include evaluating the first custom classification model and second custom classification model being updated using the third transaction dataset to compute a performance metrics. The performance metrics may include an F1 score, precision, recall, and accuracy.

In step 2230, the method 2100 may include selecting the first custom classification model or the second custom classification model as a transaction classification model based on the performance metrics. In some embodiments, the method may further include categorizing a latest transaction data to a corresponding category using the selected transaction classification model.

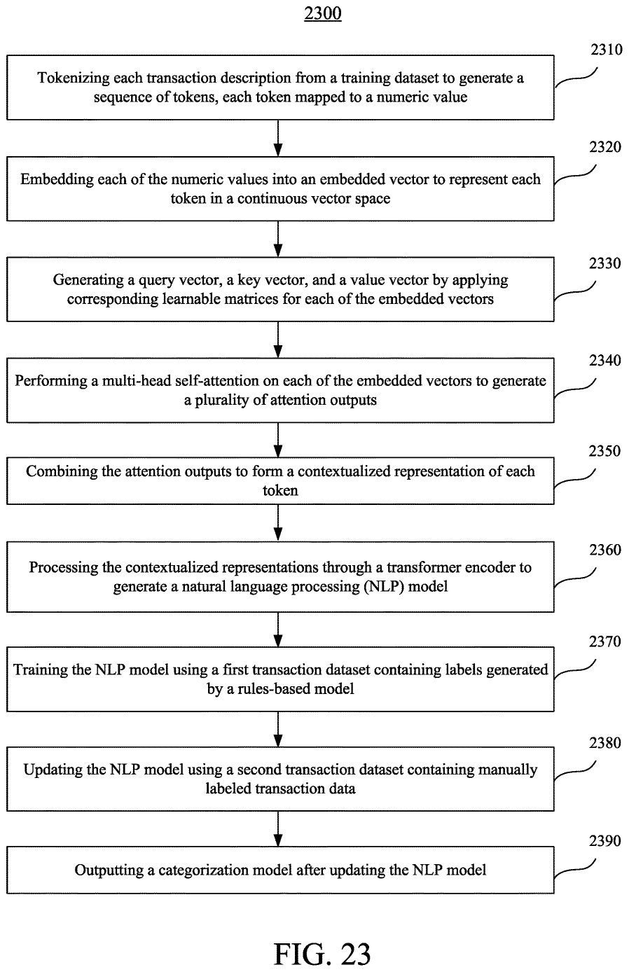

FIG. 23 illustrates a flow chart of a method 2300 for building the transaction categorization model according to an embodiment of the present disclosure. In step 2310, the method 2300 may include tokenizing each transaction description from a training dataset to generate a sequence of tokens. Each token may be mapped to a numeric value.

In step 2320, the method 2300 may include embedding each of the numeric values into an embedded vector to represent each token in a continuous vector space.

In step 2330, the method 2300 may include generating a query vector, a key vector, and a value vector by applying corresponding learnable matrices for each of the embedded vectors.

In step 2340, the method 2300 may include performing a multi-head self-attention on each of the embedded vectors to generate a plurality of attention outputs. Each attention head may process a different subspace of the embedded vector and operate in parallel.

In step 2350, the method 2300 may include combining the attention outputs to form a contextualized representation of each token.

In step 2360, the method 2300 may include processing the contextualized representations through a transformer encoder to generate a natural language processing (NLP) model. The NLP model may be pretrained from a transformer encoder.

In step 2370, the method 2300 may include training the NLP model using a first transaction dataset containing labels generated by a rules-based model.

In step 2380, the method 2300 may include updating the NLP model using a second transaction dataset containing labeled transaction data. In some embodiments, the labeled transaction data is manually labeled.

In step 2390, the method 2300 may include outputting a categorization model after updating the NLP model. The categorization model may output a classification with a probability value indicating a confidence score.

Compared to the performance plots for the first fine-tuning stage, the second stage model may achieve better performance across the metrics. For example, the final accuracy on the validation sample is 96.5% for the second fine-tuning stage compared to 90.8% for the first fine-tuning stage. This is likely because the second stage of fine-tuning can take advantage of the learning that occurred in the first stage and improve upon it, and the “ground truth” used in the second stage is likely more reliable than the first stage. The “ground truth” labels used in the first stage, which are actually predictions generated by the BSAM rules-based categories, are likely to contain more inaccuracies. The performance metrics from the first stage may struggle to reach the same levels and may take more time to reach a given level of performance compared to the second stage of fine-tuning, where the “ground truth” is based on manually assigned labels and therefore likely more reliable.

Those skilled in the art should understand that the embodiments of the present disclosure can be provided as a method, a system, or a computer program product. Accordingly, the present disclosure can take the form of an entirely hardware embodiment, an entirely software embodiment, or some embodiments combining software and hardware. Moreover, the embodiments of the present disclosure can take the form of a computer program product implemented on one or more computer usable storage media (including, but not limited to, disk memories, CD-ROMs, optical memories, etc.) comprising computer usable program codes.

The present disclosure is described with reference to the flowcharts and/or the block diagrams of a method, a device (system), and a computer program product according to the embodiments of the present disclosure. It should be understood that each process and/or block in the flowcharts and/or block diagrams, as well as combinations of the processes and/or blocks in the flowcharts and/or the block diagrams, can be implemented by computer program instructions. These computer program instructions can be provided to a processor of a computer, an embedded processor, or other programmable data processing devices to produce a machine such that a computing device for implementing the functions specified in one or more processes in the flowcharts and/or one or more blocks in the block diagrams can be produced by instructions executed by the processor of the computer or other programmable data processing devices.

These computer program instructions can also be stored in a computer readable memory that can direct a computer or other programmable data processing devices to function in a particular manner such that the instructions stored in the computer readable memory produce an article of manufacture including an instruction means which implements functions specified in one or more processes in the flowcharts and/or one or more blocks in the block diagrams.

These computer program instructions can also be loaded onto a computer or other programmable data processing devices so that a series of operating steps are performed on the computer or other programmable devices to produce computer-implemented processing. Thus the instructions executed on a computer or other programmable devices provide steps for implementing the functions specified in one or more processes in the flowcharts and/or one or more blocks in the block diagrams.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1-20. (canceled)

21. A system comprising:
a memory configured to store instructions;
a processor connected to the memory and configured to execute the instructions to:
receive a plurality of transaction datasets, each of the transaction datasets including a transaction description corresponding to a category label;
tokenize each of the transaction descriptions to generate token sequences;
generate embedded vectors based on the token sequences;
train a natural language processing (NLP) model using the embedded vectors and the category labels;
define a performance metric;
evaluate the NLP model based on the performance metric;
determine whether the performance metric meets a predefined threshold;
build a categorization model based on the trained NLP model when the performance metric meets the predefined threshold; and
categorize a latest transaction data to a corresponding category using the categorization model.

22. The system of claim 21, wherein the performance metric includes at least an F1 score, and the trained NLP model is evaluated based on the F1 score.

23. The system of claim 22, wherein the performance metric further includes at least one of a precision score, a recall score, or an accuracy score.

24. The system of claim 21, wherein the processor is further configured to execute instructions to:
monitor the performance metric during training of the NLP model across a plurality of epochs; and
apply an early stopping mechanism when the performance metric meets a degradation threshold for a predefined number of epochs.

25. The system of claim 21, wherein the processor is further configured to execute instructions to:
train a plurality of candidate models using different training datasets;
evaluate each of the candidate models using a common test dataset and the performance metric; and
select a classification model from the candidate models based on comparative performance results.

26. The system of claim 25, wherein the processor is further configured to execute instructions to:
inspect an output of the classification model by comparing a predicted label and an assigned label for each of the transaction descriptions.

27. The system of claim 26, wherein the predicted label is selected based on a highest probability among a plurality of classification probabilities generated by the classification model.

28. The system of claim 27, wherein each of the plurality of classification probabilities corresponds to a respective category, subcategory, and transaction type.

29. A method comprising:
receiving a transaction dataset including a transaction description;
tokenizing the transaction description to generate a token sequence;
converting the token sequence into an embedded vector;
inputting the embedded vector into a natural language processing (NLP) model to generate a classification output corresponding to a transaction category;
outputting the classification output with a probability value indicating a confidence score of at least one classification;
identifying a key token within the transaction description that contributes to the classification output; and
generating an analysis result based on an association between the key token and a plurality of labeled examples in the transaction dataset, the analysis result indicating reasoning behind the classification output.

30. The method of claim 29, wherein the confidence score is derived from a weighted sum of outputs from a plurality of attention heads within the NLP model.

31. The method of claim 29, wherein the analysis result is presented via a visualization interface displaying the classification output and the confidence score.

32. The method of claim 29, further comprising:
flagging the transaction description for manual review when the confidence score falls below a predefined threshold.

33. The method of claim 29, wherein identifying the key tokens includes analyzing attention weights to determine a token with a highest contribution to the NLP model.

34. The method of claim 29, further comprising:
defining a performance metric to evaluate the NLP model,
wherein the performance metric includes at least one of an accuracy, a precision, a recall, and an F1 score; and
wherein the accuracy, the precision, the recall, and the F1 score are computed based on a confusion matrix constructed from a plurality of ground truth labels of the transaction dataset and at least one predicted transaction category.

35. The method of claim 29, wherein the NLP model is pre-trained from a transformer encoder.

36. A method comprising:
tokenizing a plurality of transaction descriptions to generate a token sequence for each of the transaction descriptions;
converting the token sequences into corresponding embedded vectors;
inputting the embedded vectors into a transformer-based model including a multi-head attention mechanism to generate contextualized representations;
training the transformer-based model using a first transaction dataset to produce a custom model;
updating the custom model using a second transaction dataset;
defining a performance metric for evaluating a model performance;
evaluating the custom model being updated using a third transaction dataset based on the performance metric;
building a categorization model when the custom model meets a predefined threshold of the performance metric; and
categorizing a latest transaction data to a corresponding category by the categorization model.

37. The method of claim 36, further comprising:
generating a query vector, a key vector, and a value vector for each of the embedded vectors by performing linear projections using a set of learnable matrices;
calculating an attention score between each query vector and a corresponding plurality of key vectors based on dot product operations and scaled normalization;
applying a softmax function to the attention scores to generate a set of attention weights;
generating, for each of the embedded vectors, an attention result by computing a weighted sum of the value vectors using the attention weights; and
combining the attention results from a plurality of attention heads to produce an updated representation of the token sequence.

38. The method of claim 37, further comprising:
performing a scaling operation to limit the attention scores.

39. The method of claim 37, wherein each of the attention heads operates in parallel and processes a different subspace of the embedded vector.

40. The method of claim 36, wherein each of the performance metrics include an F1 score, a precision, and a recall, and wherein the F1 score is defined as a harmonic mean of the precision and the recall.
